(19) United States
(12) Patent Application Publication
(10) Pub. No.: US 2019/0241832 A1
(43) Pub. Date: Aug. 8, 2019

(54) Improvements in or Relating to Organic Compounds

(71) Applicant: GIVAUDAN SA, Vernier (CH)

(72) Inventor: Alan Forbes PROVAN, Ashford, Kent (GB)

(73) Assignee: GIVAUDAN SA, Vernier (CH)

(21) Appl. No.: 16/318,636

(22) PCT Filed: Aug. 8, 2017
(86) PCT No.: PCT/EP2017/069998

§ 371 Date: Jan. 17, 2019

(30) Foreign Application Priority Data
Aug. 8, 2016 (GB) 1613571.7

(51) Int. Cl. C11B 9/00

(52) U.S. Cl. CPC C11B 9/0019; C11B 9/0046; C11B 9/0034; C11B 9/008; C11B 9/0061

(57) ABSTRACT

An encapsulated perfume composition comprising malodour-counteracting perfume ingredients.

### FIELD OF THE INVENTION

This disclosure relates generally to perfume compositions adapted to mask, eliminate or prevent the perception of malodours, and to methods for masking, eliminating or preventing the perception of malodours by the application of said compositions to a situs in need of treatment.

### BACKGROUND OF THE INVENTION

There are many literature references to the malodour-counteracting effects of perfume ingredients. There are also many examples of consumer products containing perfume compositions that might contain such ingredients. Examples of products that might contain malodour-reducing perfume ingredients include room deodorants (aerosol or spray, wax-based products, wicking devices, powders or gels), laundry detergents and fabric softeners, bathroom and kitchen cleaners, personal care products, such as deodorants and antiperspirants, as well as pet care products.

Perfume ingredients, owing to their volatility, tend to exert their malodour-counteracting effect in the vapour phase. A challenge faced by formulators, therefore, is how to render these highly volatile perfume ingredients more substantive to substrates on which they are applied, in order that they can evaporate in a controlled manner therefrom to provide a long-lasting malodour counteracting effect.

One method of increasing the substantivity of perfume ingredients is to encapsulate them. The encapsulation of perfume ingredients in microcapsules, and in particular core-shell microcapsules, is well known in the art. Encapsulation provides numerous advantages, including the protection of the perfume ingredients in the microcapsule until the perfume is intended to be delivered. Microcapsules can also be adapted to deliver their contents in accordance with a desired spatio-temporal profile, by disruption of the microcapsule in response to certain external stimuli, such as heat, moisture or mechanical force. Furthermore, absent any external stimuli, perfume can simply diffusive from the microcapsule passively over a prolonged period of time.

Of course, whereas it is undesirable that perfume ingredients should leak prematurely from microcapsules, it is known that the composition of the external suspending medium in which microcapsules are dispersed can influence leakage of perfume ingredients. For example, aqueous bases that contain high levels of certain surfactants, such as hair shampoos and conditioners, as well as fabric conditioners and detergents, can be particularly efficient extractive media.

A particular challenge facing formulators is how to strike an acceptable balance between microcapsule stability (i.e. the resistance to leakage of perfume ingredients from microcapsules dispersed in a suspending medium) and microcapsule performance (that is, the ability of a microcapsule to deliver a perfume impression when required once deposited on a substrate). Typically, if microcapsules are particularly stable during storage in extractive bases, then they also tend to be rather robust in use, and will only release perfume, if at all, upon application of high shear forces. When such robust microcapsules are deposited on substrates, for example fabric, hair or skin, a perfume impression may only be noticeable, if at all, with vigorous rubbing of the treated substrate.

In addition to the effects of external suspending media, it is furthermore understood that the physical and chemical properties of perfume ingredients can have a significant effect on microcapsule stability (leakage) and performance. For example, the calculated log P_{(oil/water)} of perfume ingredients is a parameter often cited in perfume ingredient selection criteria in the creation of encapsulated perfume compositions. The volatility of perfume ingredients can also influence the stability of microcapsules, to the extent that attempts to encapsulate high amounts of the more volatile of perfume ingredients can lead to unacceptable levels of leakage. Unfortunately, however, it is the most volatile of perfume ingredients that tend to be the most useful ingredients for masking malodours.

There remains a need to provide malodour-counteracting perfume compositions that are stable under storage conditions; are substantive on substrates, such as human skin or hair, fabrics or household surfaces; and can be delivered in sufficient quantities in order to exert a longer-lasting malodour-counteractancy effect against human or environmental malodours.

### SUMMARY OF THE INVENTION

After considerable research effort, the applicant has discovered a selection of perfume ingredients that exhibit surprisingly very high malodour-counteracting properties. Still further, the applicant discovered that these ingredients can be stably incorporated into encapsulated perfume compositions at levels sufficient to exert a malodour-counteracting effect when incorporated into a consumer product and deposited onto a substrate.

The applicant also discovered perfumery ingredient selection rules that enable these malodour-counteracting perfume ingredients to be incorporated stably into encapsulated perfume compositions.

The applicant has furthermore discovered in particular that, by combining certain highly malodour-counteracting perfume ingredients with certain other perfume ingredients selected in accordance with certain perfume selection criteria disclosed herein below, it is possible to provide encapsulated perfume compositions that can be deposited onto substrates in sufficient quantities to provide long-lasting malodour-counteracting perfume benefits.

The applicant also provides consumer products, such as personal care, fabric care and household care products, containing encapsulated perfume compositions disclosed herein.

The applicant also provides a method of masking, eliminating or preventing the perception of malodours by the application of encapsulated perfume compositions defined herein to a situs in need of treatment.

### DETAILED DESCRIPTION OF THE INVENTION

The present invention is based on the discovery of the surprisingly effective malodour-counteracting properties of a group of perfume ingredients, which also can be incorporated stably into microcapsules at levels that can provide effective masking, elimination or prevention of the perception of malodour when applied to a situs in need of treatment. The stable incorporation of these malodour-counteracting perfume ingredients is enabled by the employment of certain perfume ingredient selection criteria set forth herein below.

The surprising malodour-counteracting effect of a group of perfume ingredients was discovered when assessing perfume ingredients using balanced incomplete block/six component mixture design, a description of which can be found in Montgomery, D. C. (2012), (Design and Analysis of Experiments, 8^{th} Edition John Wiley & Sons Inc.), which is hereby incorporated by reference. A test method designed to assess the malodour-counteracting effect of certain perfume ingredients is more fully described in Example 1 set forth herein below.

As a result of this assessment, a group of perfumery ingredients was found that exhibited substantially superior malodour-counteracting effects compared with other common perfumery ingredients. These ingredients can be assigned into two groups, respectively GROUP A ingredients and GROUP B ingredients, set forth here under:

GROUP A ingredients are selected from the group consisting of 3,7-dimethyloct-6-enal, e.g. Citronellal; 3,7-dimethyloct-6-en-1-ol, e.g. Citronellol; 2,4-dimethylcyclohex-3-enecarbaldehyde, e.g. Cyclal C; (E)-dec-4-enal; ethyl 2-methyl butyrate; 1-phenylethyl acetate, e.g. Gardenol; (Z)-hex-3-en-1-yl acetate; hexyl acetate; isoamyl acetate; Litsea cubeba oil; nonanal; Orange oil; Orange terpenes; prenyl acetate; 4-methyl-2-(2-methylprop-1-en-1-yl)tetrahydro-2H-pyran, e.g. Rose Oxide; 4-methylene-2-phenyltetrahydro-2H-pyran, e.g. Rosyrane super; 2,4-dimethylcyclohex-3-enecarbaldehyde; e.g. Tricyclal.

GROUP B ingredients are selected from the group consisting of 2,6,10-trimethylundec-9-enal, e.g. Adoxal; Aldehyde C 12 MNA; allyl cyclo propionate; amyl butyrate; Armoise oil Morocco; 8-(sec-butyl)-5,6,7,8-tetrahydroquinoline, e.g. Bigaryl; (2E)-3-phenylprop-2-enal, e.g. Cinnamic aldehyde; (E)-3,7-dimethylocta-2,6-dienal, e.g. Citral; ethyl caproate; 1,3,3-trimethyl-2-oxabicyclo[2.2.2]octane, e.g. Eucalyptol; Eucalyptus oil, e.g. Eucalyptus globulus oil China; 1-(1,2,8,8-tetramethyl-1,2,3,4,5,6,7,8-octahydronaphthalen-2-yl)ethanone, e.g. Georgywood; hexyl isobutyrate; (E)-4-(2,6,6-trimethylcyclohex-1-en-1-yl)but-3-en-2-one, e.g. Ionone beta; isobutyl isobutyrate; isobutyl quinolone; isopropyl methyl-2-butyrate; (2E,6Z)-3,7-dimethylnona-2,6-dienenitrile, e.g. Lemonile; 3,7-dimethylocta-1,6-dien-3-ol, e.g. Linalool; 2,6-dimethylhept-5-enal, e.g. Melonal; methyl amyl ketone; methyl benzoate; methyl heptenone; methyl hexyl ketone; phenyl ethyl acetate; tetrahydro myrcenol; Patchouli Oil; tridecen-2-nitrile; 6-methoxy-2,6-dimethyloctanal, e.g. Calypsone; 5-tert-butyl-2-methyl-5-propyl-2H-fu ran, e.g. Cassyrane; (4E)-9-hydroxy-5,9-dimethyl-4-decenal, e.g. Mahonial; 1-methyl-2-(5-methylhex-4-en-2-yl)cyclopropyl)methanol, e.g. Rosyfolia; and 3-(4-isobutyl-2-methyl phenyl)propanal, e.g. Nympheal.

In an embodiment of the invention, the applicant found that it was possible to prepare malodour-counteracting perfume compositions comprising at least 10 wt % of GROUP A perfume ingredients, and optionally at least two GROUP B perfume ingredients.

Applicant also found that it was possible to form stable encapsulated perfume compositions comprising GROUP A and optionally GROUP B ingredients following certain rules regarding perfume selection.

More specifically, the applicant herein defines a parameter of perfume ingredient selection, which describes the electron density distribution within a perfume ingredient, as reflected by the temperature-independent integral of the molecular iso-surface having electron density equal to

0.002e/a₀³

wherein

e is the dimension-less electronic charge and

a₀ is the Bohr radius of the hydrogen atom (a₀=5.2917720859×10⁻¹¹ m).

Employing Molecular Operating Environment chemical computational software (Version 2009, ex Chemical Computing Group, Canada, or later versions thereof, and optionally using the DDASSL RECON software plug-in (Rensselaer Polytechnic Institute, 2001-2003, or later versions thereof)), the value of this integral is given by the so-called RECON_VOLTAE quantum chemically derived descriptor. In particular, it was surprisingly found that the perfume ingredient loss from microcapsules is considerably reduced when the value of the molecular iso-surface integral of ingredients exceeds a certain value, more fully described herein below.

RECON_VOLTAE is a parameter that is essentially a description of the topography of a molecule iso-surface that encloses a molecular space, said iso-surface having an electron density which is equal to 0.002 e/a³₀.

As used herein, the term “known” as it is used in relation to the RECON_VOLTAE value, means the value is either known to the person skilled in the art, or can be calculated based on its chemical structure, in accordance with the teaching of the present invention.

By formulating perfume compositions in accordance with the known RECON_VOLTAE values set out herein, it is possible to form encapsulated perfume compositions characterized in that they contain sufficient quantities of malodour-counteracting perfume ingredients selected from GROUP A ingredients and optionally GROUP B ingredients to exert a desirable malodour-counteracting effect, and have a high resistance to extraction or leakage into external suspending media.

Given the fact that encapsulated perfume compositions formulated in accordance with the present invention exhibit a low propensity to leakage, it is possible to form encapsulated perfume compositions comprising at least one perfume containing core-shell microcapsule that are characterized in that the microcapsules have a very high core to shell weight ratio. More particularly, encapsulated perfume compositions of the present invention may comprise microcapsules having a core to shell weight ratio of about 80:20 to 95:5, more particularly of about 85:15 to 90:10.

Microcapsules characterized by the aforementioned core-shell weight ratio are robust enough to survive intact during the manufacturing process and other operations associated with supply chain activities, such as transportation, mixing/incorporating into consumer product bases, and storage, but are sufficiently breakable and diffusive that, in use, they can deliver long-lasting malodour-counteracting performance, and in particular both pre-rub and post-rub malodour-counteracting performance.

Without wishing to be bound by theory, it is believed that the electron density distribution of a perfume ingredient, as reflected by its known RECON_VOLTAE value, influences the efficiency with which it is encapsulated as well as the way it diffuses or leaks through the shell of a core-shell microcapsule once encapsulated. In particular, the diffusion of perfume ingredients having RECON_VOLTAE values above the threshold values recited herein, e.g. above about 1540, is delayed, or even suppressed, relative to perfume ingredients having RECON_VOLTAE values below the given 1540 threshold value. Still further, perfume ingredients with a RECON_VOLTAE value below about 1200 are particularly prone to leakage, whereas perfume ingredients with RECON_VOLTAE values above about 1750 are particularly resistant to leakage even when microcapsules containing these ingredients are suspended in particularly extractive media, such as personal cleansing bases, e.g. shampoos, as well as laundry detergent products.

Possessed with the knowledge of the RECON_VOLTAE parameter for individual perfume ingredients, and the relationship of RECON_VOLTAE to both performance and stability of encapsulated perfume compositions, the skilled person is able to create suitable encapsulated perfume compositions, by balancing the proportions of both sub- and super-threshold perfume ingredients, which are designed to be both stable and performant when used in consumer products containing more or less extractive media.

Indeed, the applicant discovered that many of the perfume ingredients having the best malodour-counteracting performance, were characterized by low RECON_VOLTAE values, for example around or below 1540, or very low values, for example around or below 1200. Encapsulated perfume compositions containing these ingredients, therefore, are preferably only provided with a desirable balance of stability and performance if they also contain significant amounts of complementary perfume ingredients having relatively high RECON_VOLTAE values, for example those above 1540 or even about 1750 or above.

Accordingly, the invention provides in one of its aspects a malodour-counteracting perfume composition comprising at least 10 wt % in total of at least two of the following perfume ingredients “A”:

3,7-dimethyloct-6-enal, e.g. Citronellal; 3,7-dimethyloct-6-en-1-ol, e.g. Citronellol; 2,4-dimethylcyclohex-3-enecarbaldehyde, e.g. Cyclal C; (E)-dec-4-enal; ethyl 2-methyl butyrate; 1-phenylethyl acetate, e.g. Gardenol; (Z)-hex-3-en-1-yl acetate; hexyl acetate; isoamyl acetate; Litsea cubeba oil; nonanal; Orange oil; Orange terpenes; prenyl acetate; 4-methyl-2-(2-methylprop-1-en-1-yl)tetrahydro-2H-pyran, e.g. Rose Oxide; 4-methylene-2-phenyltetrahydro-2H-pyran, e.g. Rosyrane super; 2,4-dimethylcyclohex-3-enecarbaldehyde; e.g. Tricyclal;

and optionally at least two of the following perfume ingredients “B”:—

2,6,10-trimethylundec-9-enal, e.g. Adoxal; Aldehyde C 12 MNA; allyl cyclo propionate; amyl butyrate; Armoise oil Morocco; 8-(sec-butyl)-5,6,7,8-tetrahydroquinoline, e.g. Bigaryl; (2E)-3-phenylprop-2-enal, e.g. Cinnamic aldehyde; (E)-3,7-dimethylocta-2,6-dienal, e.g. Citral; ethyl caproate; 1,3,3-trimethyl-2-oxabicyclo[2.2.2]octane, e.g. Eucalyptol; Eucalyptus, e.g. globulus oil China; 1-(1,2,8,8-tetramethyl-1,2,3,4,5,6,7,8-octahydronaphthalen-2-yl)ethanone, e.g. Georgywood; hexyl isobutyrate; (E)-4-(2,6,6-trimethylcyclohex-1-en-1-yl)but-3-en-2-one, e.g. Ionone beta; isobutyl isobutyrate; isobutyl quinolone; isopropyl methyl-2-butyrate; (2E,6Z)-3,7-dimethylnona-2,6-dienenitrile, e.g. Lemonile; 3,7-dimethylocta-1,6-dien-3-ol, e.g. Linalool; 2,6-dimethylhept-5-enal, e.g. Melonal; methyl amyl ketone; methyl benzoate; methyl heptenone; methyl hexyl ketone; phenyl ethyl acetate; tetrahydro myrcenol; Patchouli Oil; tridecen-2-nitrile; 6-methoxy-2,6-dimethyloctanal, e.g. Calypsone; 5-tert-butyl-2-methyl-5-propyl-2H-furan, e.g. Cassyrane; (4E)-9-hydroxy-5,9-dimethyl-4-decenal, e.g. Mahonial; 1-methyl-2-(5-methylhex-4-en-2-yl)cyclopropyl)methanol, e.g. Rosyfolia; and 3-(4-isobutyl-2-methyl phenyl)propanal, e.g. Nympheal.

In another aspect of the invention, there is provided an encapsulated perfume composition comprising at least one perfume-containing core shell microcapsule dispersed in a suspending medium, the encapsulated perfume composition comprising:—

at least 10 wt %, more particularly at least 15 wt % and still more particularly at least 20 wt %, of perfume ingredients having a known RECON_VOLTAE value higher than 1540 Bohr³;

from 20 to 90 wt %, more particularly 30 to 80 wt %, and still more particularly 50 to 75 wt %, of perfume ingredients having a known RECON_VOLTAE value lower than 1540 Bohr³;

wherein the encapsulated perfume composition contains at least 10 wt % in total of at least two of the perfume ingredients “A” referred to hereinabove; and optionally at least two of the perfume ingredients “B” referred to hereinabove.

In an embodiment of the present invention, the encapsulated perfume composition contains 30 to 70 wt %, more particularly 40 to 65 wt %, and more particularly still 50 to 60 wt %, in total of at least 4 compounds drawn from perfume ingredients “A” and “B”.

In another aspect of the invention, there is provided a method of preparing an encapsulated perfume composition comprising the step of forming an emulsion comprising at least one perfume-containing oil droplet suspended in an aqueous external phase, and causing shell-forming material to form an encapsulating polymeric shell around said droplet to form a core-shell microcapsule, wherein the perfume ingredients comprise “A” and optionally “B” ingredients in the amounts referred to above, and wherein the perfume ingredients are selected on the basis of their known RECON_VOLTAE values such that the encapsulated perfume composition comprises at least 10 wt %, more particularly at least 15 wt % and still more particularly at least 20 wt %, of perfume ingredients having a known RECON_VOLTAE value higher than 1540 Bohr³; and from 20 to 90 wt %, more particularly 30 to 80 wt %, and still more particularly 50 to 75 wt %, of perfume ingredients having a known RECON_VOLTAE value lower than 1540 Bohr³.

In yet another aspect of the invention, there is provided a method of incorporating “A” ingredients and optionally “B” ingredients into an encapsulated perfume composition, the method comprising the step of preparing a perfume composition comprising ingredients “A” and optionally ingredients “B” in the amounts defined herein above, and optionally any other perfume ingredients, wherein the other perfume ingredients are selected on the basis of their known RECON_VOLTAE values such that the perfume composition comprises at least 10 wt %, more particularly at least 15 wt % and still more particularly at least 20 wt %, of perfume ingredients having a RECON_VOLTAE value higher than 1540 Bohr³; and from 20 to 90 wt %, more particularly 30 to 80 wt % and still more particularly 50 to 75 wt %, of perfume ingredients having a RECON_VOLTAE value lower than 1540 Bohr³.

RECON_VOLTAE values can be calculated for individual perfume ingredients in the manner described hereinabove. However, for reference, RECON_VOLTAE values for some representative perfume ingredients that are useful in said encapsulated perfume compositions are provided in the following table.

| Perfumery ingredient | RECON_VOLTAE (Bohr³) |
|---|---|
| HEDIONE (methyl 3-oxo-2-pentylcyclopentaneacetate) | 1784 |
| ALLYL CYCLOHEXYL PROPIONATE (allyl 3- | 1606 |
| cyclohexylpropanoate) | |
| AGRUMEX (2-(tert-butyl)cyclohexyl acetate) | 1678 |
| DIMETHYL BENZYL CARBINYL ACETATE (2-methyl-1- | 1506 |
| phenylpropan-2-yl acetate) | |
| IRISONE ALPHA ((E)-4-(2,6,6-trimethylcyclohex-2-en-1-yl)but-3- | 1676 |
| en-2-one) | |
| ISO E SUPER (1-(2,3,8,8-tetramethyl-1,2,3,4,5,6,7,8- | 2024 |
| octahydronaphthalen-2-yl)ethanone) | |
| ISORALDEINE 70 ((E)-3-methyl-4-(2,6,6-trimethylcyclohex-2-en-1- | 1806 |
| yl)but-3-en-2-one) | |
| NECTARYL (2-(2-(4-methylcyclohex-3-en-1- | 1822 |
| yl)propyl)cyclopentanone) | |
| BOISAMBRENE FORTE ((ethoxymethoxy)cyclododecane) | 2063 |
| BOISIRIS ((1S,2R,5R)-2-ethoxy-2,6,6-trimethyl-9- | 1914 |
| methylenebicyclo[3.3.1]nonane) | |
| JASMACYCLENE ((3aR,6S,7aS)-3a,4,5,6,7,7a-hexahydro-1H-4,7- | 1418 |
| methanoinden-6-yl acetate) | |
| FLOROCYCLENE ((3aR,6S,7aS)-3a,4,5,6,7,7a-hexahydro-1H-4,7- | 1549 |
| methanoinden-6-yl propionate) | |
| HEXYL SALICYLATE (hexyl 2-hydroxybenzoate) | 1685 |
| DIPENTENE (1-methyl-4-(prop-1-en-2-yl)cyclohex-1-ene) | 1203 |
| TETRAHYDRO LINALOOL (3,7-dimethyloctan-3-ol) | 1449 |
| AMYL SALICYLATE (pentyl 2-hydroxybenzoate) | 1556 |
| ALDEHYDE C 12 MNA PURE (2-methylundecanal) | 1661 |
| BUTYL CYCLOHEXYL ACETATE PARA (4-(tert-butyl)cyclohexyl | 1682 |
| acetate) | |
| DAMASCONE DELTA ((E)-1-(2,6,6-trimethylcyclohex-3-en-1- | 1654 |
| yl)but-2-en-1-one) | |
| DIMETHYL BENZYL CARBINYL BUTYRATE (2-methyl-1- | 1767 |
| phenylpropan-2-yl butyrate) | |
| EUCALYPTOL ((1s,4s)-1,3,3-trimethyl-2-oxabicyclo[2.2.2]octane) | 1278 |
| FRUTONILE (2-methyldecanenitrile) | 1597 |
| HEXYL CINNAMIC ALDEHYDE ((E)-2-benzylideneoctanal) | 1778 |
| TERPINYL ACETATE (2-(4-methylcyclohex-3-en-1-yl)propan-2-yl | 1590 |
| acetate) | |
| UNDECAVERTOL ((E)-4-methyldec-3-en-5-ol) | 1531 |
| GARDOCYCLENE ((3aR,6S,7aS)-3a,4,5,6,7,7a-hexahydro-1H-4,7- | 1677 |
| methanoinden-6-yl isobutyrate) | |
| LILIAL (3-(4-(tert-butyl)phenyl)-2-methylpropanal) | 1738 |
| LINALYL ACETATE (3,7-dimethylocta-1,6-dien-3-yl acetate) | 1653 |
| GERANIOL ((E)-3,7-dimethylocta-2,6-dien-1-ol) | 1357 |
| ALLYL OENANTHATE (allyl heptanoate) | 1436 |
| PETALIA (2-cyclohexylidene-2-(o-tolyl)acetonitrile) | 1753 |
| NEOBERGAMATE FORTE (2-methyl-6-methyleneoct-7-en-2-yl | 1650 |
| acetate) | |
| ISONONYL ACETATE (3,5,5-trimethylhexyl acetate) | 1632 |
| FRESKOMENTHE (2-(sec-butyl)cyclohexanone) | 1313 |
| ORIVONE (4-(tert-pentyl)cyclohexanone) | 1474 |
| NONADYL (6,8-dimethylnonan-2-ol) | 1579 |
| METHYL PAMPLEMOUSSE (6,6-dimethoxy-2,5,5-trimethylhex-2- | 1632 |
| ene) | |
| ETHYL CAPRYLATE (ethyl octanoate) | 1462 |
| AMBER CORE (1-((2-(tert-butyl)cyclohexyl)oxy)butan-2-ol) | 1972 |
| CASHMERAN (1,1,2,3,3-pentamethyl-2,3,6,7-tetrahydro-1H-inden- | 1772 |
| 4(5H)-one) | |
| DAMASCENONE ((E)-1-(2,6,6-trimethylcyclohexa-1,3-dien-1- | 1608 |
| yl)but-2-en-1-one) | |
| ETHYL SAFRANATE (ethyl 2,6,6-trimethylcyclohexa-1,3-diene-1- | 1579 |
| carboxylate) | |
| PEONILE (2-cyclohexylidene-2-phenylacetonitrile) | 1633 |
| DELPHONE (2-pentylcyclopentanone) | 1313 |
| SILVIAL (3-(4-isobutylphenyl)-2-methylpropanal) | 1700 |
| CITRONELLYL PROPIONATE (3,7-dimethyloct-6-en-1-yl | 1808 |
| propionate) | |
| CYCLOHEXYL SALICYLATE (cyclohexyl 2-hydroxybenzoate) | 1610 |
| CORANOL (4-cyclohexyl-2-methylbutan-2-ol) | 1486 |
| BORNYL ACETATE ((2S,4S)-1,7,7-trimethylbicyclo[2.2.1]heptan-2- | 1631 |
| yl acetate) | |
| ALDEHYDE C 10 (decanal) | 1403 |
| ALDEHYDE C 11 (undecanal) | 1533 |
| ALDEHYDE MANDARINE 10% in TEC ((E)-dodec-2-enal) | 1615 |
| AMBERMAX (1,3,4,5,6,7-hexahydro-.beta.,1,1,5,5-pentamethyl-2H- | 2275 |
| 2,4a-Methanonaphthalene-8-ethanol) | |
| BELAMBRE ((1R,2S,4R)-2′-isopropyl-1,7,7- | 2112 |
| trimethylspiro[bicyclo[2.2.1]heptane-2,4′-[1,3]dioxane]) | |
| CITRONELLYL NITRILE (3,7-dimethyloct-6-enenitrile) | 1429 |
| FLORHYDRAL (3-(3-isopropylphenyl)butanal) | 1568 |
| GERANYL ACETATE SYNTHETIC ((E)-3,7-dimethylocta-2,6-dien- | 1643 |
| 1-yl acetate) | |
| HABANOLIDE ((E)-oxacyclohexadec-12-en-2-one) | 1978 |
| MYRALDENE (4-(4-methylpent-3-en-1-yl)cyclohex-3- | 1613 |
| enecarbaldehyde) | |
| TRIDECENE-2-NITRILE ((E)-tridec-2-enenitrile) | 1818 |
| ROSACETOL (2,2,2-trichloro-1-phenylethyl acetate) | 1731 |
| CITRONELLYL ACETATE (3,7-dimethyloct-6-en-1-yl acetate) | 1678 |
| ETHYL LINALOOL ((E)-3,7-dimethylnona-1,6-dien-3-ol) | 1497 |
| GERANYL ISOBUTYRATE ((E)-3,7-dimethylocta-2,6-dien-1-yl | 1901 |
| isobutyrate) | |
| RADJANOL SUPER ((E)-2-ethyl-4-(2,2,3-trimethylcyclopent-3-en-1- | 1829 |
| yl)but-2-en-1-ol) | |
| TERPINOLENE (1-methyl-4-(propan-2-ylidene)cyclohex-1-ene) | 1204 |
| ETHYL LINALYL ACETATE ((Z)-3,7-dimethylnona-1,6-dien-3-yl | 1783 |
| acetate) | |
| SERENOLIDE (2-(1-(3,3-dimethylcyclohexyl)ethoxy)-2- | 2429 |
| methylpropyl cyclopropanecarboxylate) | |
| CITRAL ((E)-3,7-dimethylocta-2,6-dienal) | 1311 |
| DIMETHYL OCTENONE (4,7-dimethyloct-6-en-3-one) | 1360 |
| GALBANONE PURE (1-(3,3-dimethylcyclohex-1-en-1-yl)pent-4-en- | 1663 |
| 1-one) | |
| KOAVONE ((Z)-3,4,5,6,6-pentamethylhept-3-en-2-one) | 1675 |
| NEROLIDYLE ((Z)-3,7,11-trimethyldodeca-1,6,10-trien-3-yl acetate) | 2257 |
| MENTHOL NATURAL (2-isopropyl-5-methylcyclohexanol) | 1357 |
| ALDEHYDE C 12 (dodecanal) | 1662 |
| COSMONE ((Z)-3-methylcyclotetradec-5-enone) | 1924 |
| CYCLAMEN ALDEHYDE (3-(4-isopropylphenyl)-2- | 1567 |
| methylpropanal) | |
| DIMETHYL BENZYL CARBINOL (2-methyl-1-phenylpropan-2-ol) | 1223 |
| FLORALOZONE (3-(4-ethylphenyl)-2,2-dimethylpropanal) | 1608 |
| HERBANATE ((2S)-ethyl 3-isopropylbicyclo[2.2.1]hept-5-ene-2- | 1629 |
| carboxylate) | |
| DIMETOL (2,6-dimethylheptan-2-ol) | 1320 |
| PIVAROSE (2,2-dimethyl-2-pheylethyl propanoate) | 1665 |
| PRECYCLEMONE B (1-methyl-4-(4-methylpent-3-en-1-yl)cyclohex- | 1783 |
| 3-enecarbaldehyde) | |
| ALDEHYDE C 11 UNDECYLENIC (undec-10-enal) | 1498 |
| ETHYL OENANTHATE (ethyl heptanoate) | 1333 |
| KARANAL (5-(sec-butyl)-2-(2,4-dimethylcyclohex-3-en-1-yl)-5- | 2242 |
| methyl-1,3-dioxane) | |
| NERYL ACETATE HC ((Z)-3,7-dimethylocta-2,6-dien-1-yl acetate) | 1643 |
| THIBETOLIDE (oxacyclohexadecan-2-one) | 2017 |
| FLOROPAL (2,4,6-trimethyl-4-phenyl-1,3-dioxane) | 1596 |
| GIVESCONE (ethyl 2-ethyl-6,6-dimethylcyclohex-2-enecarboxylate) | 1754 |
| TERPINENE GAMMA (1-methyl-4-propan-2-ylcyclohexa-1,4-diene) | 1205 |
| FIXOLIDE (1-(3,5,5,6,8,8-hexamethyl-5,6,7,8-tetrahydronaphthalen- | 2207 |
| 2-yl)ethanone) | |
| METHYL CEDRYL KETONE (1-((1S,8aS)-1,4,4,6-tetramethyl- | 2076 |
| 2,3,3a,4,5,8-hexahydro-1H-5,8a-methanoazulen-7-yl)ethanone) | |
| PARADISAMIDE (2-ethyl-N-methyl-N-(m-tolyl)butanamide) | 1790 |
| RASPBERRY KETONE (N112) (4-(4-hydroxyphenyl)butan-2-one) | 1243 |
| NEOFOLIONE ((E)-methyl non-2-enoate) | 1418 |
| APHERMATE (1-(3,3-dimethylcyclohexyl)ethyl formate) | 1549 |
| CARYOPHYLLENE ((Z)-4,11,11-trimethyl-8- | 1809 |
| methylenebicyclo[7.2.0]undec-4-ene) | |
| STEMONE ((E)-5-methylheptan-3-one oxime) | 1250 |
| EBANOL ((E)-3-methyl-5-(2,2,3-trimethylcyclopent-3-en-1-yl)pent- | 1832 |
| 4-en-2-ol) | |
| CYCLOMYRAL (8,8-dimethyl-1,2,3,4,5,6,7,8-octahydronaphthalene- | 1610 |
| 2-carbaldehyde) | |
| FENCHYL ACETATE ((2S)-1,3,3-trimethylbicyclo[2.2.1]heptan-2-yl | 1628 |
| acetate) | |
| JASMONE CIS ((Z)-3-methyl-2-(pent-2-en-1-yl)cyclopent-2-enone) | 1379 |
| METHYL NONYL KETONE EXTRA (undecan-2-one) | 1532 |
| SYLKOLIDE ((E)-2-((3,5-dimethylhex-3-en-2-yl)oxy)-2- | 2177 |
| methylpropyl cyclopropanecarboxylate) | |
| BUTYL BUTYRO LACTATE (1-butoxy-1-oxopropan-2-yl butyrate) | 1680 |
| ALDEHYDE ISO C 11 ((E)-undec-9-enal) | 1491 |
| ROSALVA (dec-9-en-1-ol) | 1397 |
| VIRIDINE ((2,2-dimethoxyethyl)benzene) | 1281 |
| FRUITATE ((3aS,4S,7R,7aS)-ethyl octahydro-1H-4,7- | 1617 |
| methanoindene-3a-carboxylate) | |
| CITRONELLYL FORMATE (3,7-dimethyloct-6-en-1-yl formate) | 1544 |
| IRONE ALPHA ((E)-4-(2,5,6,6-tetramethylcyclohex-2-en-1-yl)but-3- | 1800 |
| en-2-one) | |
| MENTHONE (2-isopropyl-5-methylcyclohexanone) | 1312 |
| HEXENYL-3-CIS BUTYRATE ((Z)-hex-3-en-1-yl butyrate) | 1421 |
| ALDEHYDE C 11 MOA (2-methyldecanal) | 1530 |
| CLONAL (dodecanenitrile) | 1723 |
| DAMASCONE ALPHA ((E)-1-(2,6,6-trimethylcyclohex-2-en-1- | 1657 |
| yl)but-2-en-1-one) | |
| DUPICAL ((E)-4-((3aS,7aS)-hexahydro-1H-4,7-methanoinden-5(6H)- | 1607 |
| ylidene)butanal) | |
| FENCHYL ALCOHOL ((1S,2R,4R)-1,3,3- | 1345 |
| trimethylbicyclo[2.2.1]heptan-2-ol) | |
| INDOFLOR (4,4a,5,9b-tetrahydroindeno[1,2-d][1,3]dioxine) | 1245 |
| MALTYL ISOBUTYRATE (2-methyl-4-oxo-4H-pyran-3-yl | 1398 |
| isobutyrate) | |
| METHYL OCTYNE CARBONATE (methyl non-2-ynoate) | 1376 |
| PELARGENE (2-methyl-4-methylene-6-phenyltetrahydro-2H-pyran) | 1480 |
| PYRALONE (6-(sec-butyl)quinoline) | 1466 |
| SUPER MUGUET ((E)-6-ethyl-3-methyloct-6-en-1-ol) | 1522 |
| VELOUTONE (2,2,5-trimethyl-5-pentylcyclopentanone) | 1778 |
| RHUBAFURANE (2,2,5-trimethyl-5-pentylcyclopentanone) | 1434 |
| SPIROGALBANONE (1-(spiro[4.5]dec-6-en-7-yl)pent-4-en-1-one) | 1850 |
| DIHYDRO ANETHOLE (propanedioic acid 1-(1-(3,3- | 1219 |
| dimethylcyclohexyl)ethyl) 3-ethyl ester) | |
| ZINARINE (2-(2,4-dimethylcyclohexyl)pyridine) | 1557 |
| BIGARYL (8-(sec-butyl)-5,6,7,8-tetrahydroquinoline) | 1563 |
| CASSYRANE (5-tert-butyl-2-methyl-5-propyl-2H-furan) | 1624 |
| MANZANATE (ethyl 2-methylpentanoate) | 1202 |
| NONENAL-6-CIS ((Z)-non-6-enal) | 1234 |
| ALLYL AMYL GLYCOLATE (allyl 2-(isopentyloxy)acetate) | 1495 |
| DIHYDRO JASMONE (3-methyl-2-pentylcyclopent-2-enone) | 1409 |
| ISOCYCLOCITRAL (2,4,6-trimethylcyclohex-3-enecarbaldehyde) | 1266 |
| LEAF ACETAL ((Z)-1-(1-ethoxyethoxy)hex-3-ene) | 1457 |
| CYCLOGALBANATE (allyl 2-(cyclohexyloxy)acetate) | 1546 |
| LIFFAROME ((Z)-hex-3-en-1-yl methyl carbonate) | 1218 |
| CITRATHAL R ((Z)-1,1-diethoxy-3,7-dimethylocta-2,6-diene) | 1933 |
| ROSYFOLIA ((1-methyl-2-(5-methylhex-4-en-2-yl)cyclopropyl)- | 1685 |
| methanol) | |
| ALDEHYDE MANDARINE ((E)-dodec-2-enal) | 1615 |
| BELAMBRE 50% in IPM ((1R,2S,4R)-2′-isopropyl-1,7,7- | 2112 |
| trimethylspiro[bicyclo[2.2.1]heptane-2,4′-[1,3]dioxane]) | |
| AMBROCENIDE ((4aR,5R,7aS,9R)-Octahydro-2,2,5,8,8,9a- | 2339 |
| hexamethyl-4H-4a,9-methanoazuleno[5,6-d]-1,3-dioxole) | |
| CITRONELLAL (3,7-dimethyloct-6-enal) | 1363 |
| CITRONELLOL (3,7-dimethyloct-6-en-1-ol) | 1392 |
| CYCLAL C (2,4-dimethylcyclohex-3-enecarbaldehyde) | 1138 |
| DECENAL-4-TRANS ((E)-dec-4-enal) | 1363 |
| HEXENYL-3-CIS ACETATE ((Z)-hex-3-en-1-yl acetate) | 1162 |
| HEXYL ACETATE (hexyl acetate) | 1202 |
| NONANAL | 1274 |
| ROSE OXIDE (4-methyl-2-(2-methylprop-1-en-1-yl)tetrahydro-2H- | 1320 |
| pyran) | |
| ROSYRANE SUPER (4-methylene-2-phenyltetrahydro-2H-pyran) | 1353 |
| ADOXAL (2,6,10-trimethylundec-9-enal) | 1878 |
| AMYL BUTYRATE (pentyl butanoate) | 1333 |
| ANTHER ((2-(isopentyloxy)ethyl)benzene) | 1597 |
| CALYPSONE (6-methoxy-2,6-dimethyloctanal) | 1596 |
| CINNAMIC ALDEHYDE ((2E)-3-phenylprop-2-enal) | 1001 |
| ETHYL CAPROATE (ethyl hexanoate) | 1203 |
| GEORGYWOOD (1-(1,2,8,8-tetramethyl-1,2,3,4,5,6,7,8- | 2037 |
| octahydronaphthalen-2-yl)ethanone) | |
| HEXYL ISOBUTYRATE (hexyl 2-methylpropanoate) | 1460 |
| ISOBUTYL ISOBUTYRATE (2-methylpropyl 2-methylpropanoate) | 1202 |
| ISOPROPYL METHYL-2-BUTYRATE (isopropyl 2- | 1212 |
| methylbutanoate) | |
| LEMONILE ((2E,6Z)-3,7-dimethylnona-2,6-dienenitrile) | 1515 |
| MAHONIAL ((4E)-9-hydroxy-5,9-dimethyl-4-decenal) | 1685 |
| MELONAL (2,6-dimethylhept-5-enal) | 1229 |
| METHYL AMYL KETONE (heptan-2-one) | 1015 |
| METHYL BENZOATE (methyl benzoate) | 981 |
| METHYL HEPTENONE PURE (6-methylhept-5-en-2-one) | 1101 |
| METHYL HEXYL KETONE (octan-2-one) | 1144 |
| NYMPHEAL (3-(4-isobutyl-2-methylphenyl)propanal) | 1700 |
| PHENYL ETHYL ACETATE (2-phenethyl acetate) | 1237 |
| ETHYL METHYL-2-BUTYRATE (ethyl 2-methylbutanoate) | 1069 |
| GARDENOL (1-phenylethyl acetate) | 1246 |
| ISOAMYL ACETATE (isopentyl acetate) | 1075 |
| PRENYL ACETATE (3-methylbut-2-en-1-yl acetate) | 1039 |
| TRICYCLAL (2,4-dimethylcyclohex-3-enecarbaldehyde) | 1138 |
| IONONE BETA ((E)-4-(2,6,6-trimethylcyclohex-1-en-1-yl)but-3-en- | 1670 |
| 2-one) | |
| ISOBUTYL QUINOLINE-2 (6-butan-2-yl-quinoline) | 1473 |
| LINALOOL SYNTHETIC (3,7-dimethylocta-1,6-dien-3-ol) | 1367 |
| TETRAHYDRO MYRCENOL (2,6-dimethyloctan-2-ol) | 1449 |
| Litsea cubeba oil China | 1311 ⁽¹⁾ |
| Eucalyptus globulus oil China cosmos | 1260 ⁽²⁾ |
| Patchouli oil iron free Indonesia | 1750 ⁽³⁾ |
| Orange oil Brazil | 1203 ⁽⁴⁾ |
| Orange terpenes | 1203 ⁽⁴⁾ |
| Cabylis 4/20 | 1350 ⁽⁵⁾ |
| Galbanum res synth IFRA/20/2 | 1203 ⁽⁵⁾ |

⁽¹⁾ Litsea cubeba oil China = 75% CITRAL + 17% DIPENTENE + 2.3% LINALOOL + 1.4% GERANIOL + monoterpenes. The values provided is that of CITRAL and can be taken as a good estimate of the weighted average RECON_VOLTAE of the oil.
⁽²⁾ Eucalyptus globulus oil China cosmos = 85% EUCALYPTOL + 12% monoterpenes. The value provide us a weighted average RECON_VOLTAE estimate
⁽³⁾ Estimated weighted average RECON_VOLTAE, based on PATCHOULI ALCOHOL (4,8a,9,9-tetramethyldecahydro-1,6-methanonaphthalen-1-ol), GUAIENE (1,4-dimethyl-7-prop-1-en-2-yl-1,2,3,4,5,6,7,8-octahydroazulene), triterpenes and terpenes.
⁽⁴⁾ The value provided is that of DIPENTENE > 96% in the composition of both orange oils and orange terpenes.
⁽⁵⁾ Estimated weighted average RECON_VOLTAE, based on composition.

In yet another aspect of the invention, there is provided a method of masking, eliminating or preventing the perception of malodours by the application of said encapsulated perfume 15 compositions to a situs in need of treatment.

As used herein in relation to the GROUP A and GROUP B perfume ingredients, the term “wt %” refers to the concentration of a perfume ingredient or group of perfume ingredients, relative to the total amount of the material to be encapsulated.

It should be understood that if a GROUP A or GROUP B perfume ingredient is employed diluted or dissolved in a solvent or diluent, for the purpose of calculating the amount of perfume ingredient present in the material to be encapsulated, only the contribution of the perfume ingredient and not the solvent or diluent is to be taken into account.

Such solvents or diluents are hydrophobic materials that are miscible in the perfume ingredients, and which have little or no odour in the quantities employed. Solvents commonly employed may have high C log P values, for example greater than 6 and even greater than 10. Solvents include, but are not limited to, triglyceride oil, mono and diglycerides, mineral oil, silicone oil, diethyl phthalate, poly(alpha-olefins), castor oil, triethyl citrate (TEC), and isopropyl myristate.

The material to be encapsulated may also contain commonly employed adjuvants. The term “adjuvants” refers to ingredients that may affect the performance of a composition in a manner other than its hedonic performance. For example, an adjuvant may be an ingredient that acts as an aid to processing a perfume composition or consumer product containing said composition, or it may improve handling or storage of a perfume composition or consumer product. It might also be an ingredient that provides additional benefits, such as imparting colour or texture. It might also be an ingredient that imparts light resistance or chemical stability to one or more ingredients contained in a perfume composition or consumer product. A detailed description of the nature and type of adjuvants commonly used in perfume compositions or consumer products cannot be exhaustive; but it has to be mentioned that said ingredients are well known to a person skilled in the art. Examples of adjuvants include surfactants and emulsifiers; viscosity and rheology modifiers; thickening and gelling agents; preservative materials; pigments, dyestuffs and colouring matters; extenders, fillers and reinforcing agents; stabilisers against the detrimental effects of heat and light, bulking agents, acidulants, buffering agents and antioxidants. When present in the material to be encapsulated, the total amount of such adjuvants amounts to less than about 10 wt % based on the total material to be encapsulated, more particularly less than 5 wt %, less than 4 wt %, less than 3 wt %, less than 2 wt %, and more particularly 1 wt % or less.

In an encapsulated perfume composition, the concentration of perfume-containing core-shell microcapsules in the suspending medium may be from 0.01 to 5 wt % based on the total weight of the encapsulated perfume composition.

The perfume containing core-shell microcapsules may have a volume average diameter (d 50) from 1 to 250 microns, more particularly 2 to 50 microns, still more particularly about 3 to about 20 microns. Mean diameter (d 50) values are obtained by conducting laser diffraction light scattering measurements using a Malvern 2000S instrument, using techniques generally known in the art.

The perfume containing core-shell microcapsules may be adapted to be ruptured to release perfume contained in the core under a rupture force of less than 2 milli Newtons (mN), more particularly less than 1.5 mN, still more particularly less than 1.0 mN, e.g. from 2 mN to 0.025 mN.

The rupture force needed to rupture the perfume-containing microcapsules can be measured by a technique known in the art as micro-manipulation. The principle of the micro-manipulation technique is to compress single microcapsules between two parallel surfaces. Single microcapsules are compressed and held, compressed and released, and compressed to large deformations or rupture at a pre-set speed. Simultaneously, the force being imposed on them and their deformation can be determined. The technique uses a fine probe, about 10 μm in diameter, positioned perpendicular to the surface of the capsule sample. The probe is connected to a force transducer, which is mounted on a 3-dimensional micro-manipulator that can be programmed to travel at a given speed. The whole process is carried out on an inverted microscope. From the curve of force versus sampling time, the relationship between the force and the microcapsule deformation to bursting, and its initial diameter are obtained.

The technique of micro-manipulation is more fully explained in Zhang, Z., Saunders, R. and Thomas, C. R., Micromanipulation measurements of the bursting strength of single microcapsules, Journal of Microencapsulation 16(1), 117-124 (1999), which document is incorporated herein by reference.

The shell of the perfume containing core-shell microcapsule may be formed of any suitable polymeric materials for use in the formation of encapsulated perfume compositions, for example aminoplast polymers, that are based on melamine formaldehyde, urea formaldehyde or melamine urea formaldehyde resins; polyurea; polyamide; polyurethane; gelatin; starch; or polymers based on acrylic acid or acrylates.

In a particular embodiment of the present invention, the shell of said perfume containing core-shell microcapsule is formed of an aminoplast resin, more particularly an aminoplast resin that comprises a melamine-formaldehyde aminoplast terpolymer, which contains residues of a polyol, and particularly residues of aromatic polyols, such as resorcinol.

In a more particular embodiment, the shell of said perfume containing core-shell microcapsule is formed of 75-100 wt % of a thermoset resin comprising 50-90 wt %, preferably from 60-85 wt %, of a terpolymer and from 10-50 wt %, preferably from 10-25 wt %, of a polymeric stabilizer; the terpolymer comprising:
(a) from 20-60 wt %, preferably 30-50 wt % of moieties derived from at least one polyamine;
(b) from 3-50 wt %, preferably 5-25 wt % of moieties derived from at least one aromatic polyol; and
(c) from 20-70 wt %, preferably 40-60 wt % of moieties selected from the group consisting of alkylene and alkylenoxy moieties having 1 to 6 methylene units, preferably 1 to 4 methylene units and most preferably 1 methylene unit, and dimethoxy methylene; the microcapsule shell optionally comprising up to 25 wt %, more particularly up to 10 wt % of a cationic polymer deposition aid.

Examples of suitable aminoplast core-shell microcapsules are disclosed in PCT application WO 2008/098387, which is herein incorporated by reference.

Other suitable aminoplast microcapsules are those that are formed when an amino-aldehyde pre-condensate, for example a melamine-formaldehyde pre-condensate, undergoes a poly-condensation reaction and is cross-linked with a diamine cross-linker during the encapsulation process.

Accordingly, in a particular embodiment of the invention, the encapsulated perfume composition comprises at least one perfume containing core-shell microcapsule capsule the shell of which comprises a network of cross-linked aminoplast resin, wherein 75-100 wt % of the shell is formed of 50-90 wt %, preferably from 60-85 wt % of a terpolymer comprising:
(a) from 20-35 wt %, preferably 22-30 wt % of moieties derived from at least one triamine;
(b) from 30-60 wt %, preferably 40-55 wt % of moieties derived from at least one diamine, and
(c) from 20-35 wt %, preferably 22-30 wt % of moieties derived from the group consisting of alkylene and alkylenoxy moieties having 1 to 6 methylene units, preferably 1 to 4 methylene units and most preferably 1 methylene unit.

Examples of such aminoplast perfume containing core-shell microcapsules are disclosed in co-pending PCT application PCT/EP2016/065538, which is herein incorporated by reference.

Other suitable perfume containing core-shell microcapsules based on aminoplast resins are aminoplast microcapsules that are stabilized during their formation by means of a positively charged polymeric colloidal stabilizer. Such microcapsules are disclosed in co-pending PCT application PCT/EP2016/064344, which is herein incorporated by reference.

In another particular embodiment, the encapsulated fragrance composition comprises perfume-containing starch microparticles, each particle comprising a perfume encapsulated within a matrix of a water soluble, modified starch.

Starches suitable for encapsulating fragrance compositions are modified starches, which can be made from raw starch, pre-gelatinized starch, modified starch derived from tubers, legumes, cereal and grains, for example corn starch, wheat starch, rice starch, waxy corn starch, oat starch, cassava starch, waxy barley, waxy rice starch, sweet rice starch, amioca, potato starch, tapioca starch and mixtures thereof.

Modified starches suitable for use as the encapsulating matrix in the present invention include starches that are modified chemically, physically, e.g. through heat or pressure, or enzymatically. They include hydrolyzed starch, acid thinned starch, starch esters of long chain hydrocarbons, starch acetates, starch octenyl succinate, and mixtures thereof.

Starch esters having a degree of substitution in the range of from about 0.01% to about 10.0% may be used to encapsulate the fragrance composition. The hydrocarbon part of the modifying ester should be from a C5 to C16 carbon chain.

The term “hydrolyzed starch” refers to oligosaccharide-type materials that are typically obtained by acid and/or enzymatic hydrolysis of starches, preferably corn starch. Suitable hydrolyzed starches for inclusion in the present invention include dextrins, for example those described in U.S. Pat. No. 3,455,838, and maltodextrins. The hydrolyzed starches may have a Dextrose Equivalent (DE) value of about 10 to about 36 DE. The DE value is a measure of the reducing equivalence of the hydrolyzed starch referenced to dextrose and expressed as a percent (on a dry basis). The higher the DE value, the more reducing sugars present. A method for determining DE values can be found in Standard Analytical Methods of the Member Companies of Corn Industries Research Foundation, 6th ed. Corn Refineries Association, Inc. Washington, D.C. 1980, D-52.

Whereas native starch is hydrophilic and is not particularly useful to encapsulate hydrophobic substances, which practically all perfume ingredients are, it is necessary to use modified starches, such as the modified starches described above. Modified starches have emulsifying and emulsion-stabilizing capacity, and have the ability to entrap fragrance composition oil droplets in the form of oil-in-water emulsions due to the hydrophobic character of the starch modifying agent.

The emulsions can then be de-hydrated, for example by mechanical drying techniques such as spray drying, to form starch encapsulated fragrance compositions of the present invention in particulate form.

A range of commercially available starches are produced and include specialty modified starches such as Hi-Cap®, Capsul® and N-Lok® brands.

Modified starches as described herein bring numerous advantages, including excellent emulsification and encapsulation performance; low viscosity, even at high solids content, thereby providing faster drying rates under mechanical drying with lower energy consumption; and low surface oil and excellent oxidation resistance to ensure good fragrance preservation and stabilization of sensitive ingredients.

The encapsulated perfume compositions as herein defined may be incorporated into all manner of consumer product bases to impart odour-elimination and perfumery benefits thereto.

Accordingly, in another aspect of the present invention, there is provided a consumer product containing an encapsulated perfume composition as herein defined.

In a particular embodiment of the present invention, the consumer product is selected from talcum powder, deodorants and antiperspirants, lotions, and oils, soap, syndet, soap and syndet personal wash bars, personal wash liquids, and personal wipes, diapers, pantiliners and sanitary products, shampoos, conditioners, styling sprays, mousses, gels, hair wipes, hair sprays, and hair pomades, cosmetic products, creams, fabric washing liquids and powders, fabric conditioners, laundry detergents, laundry softeners or conditioners, wipes, dishwashing liquids and powders, hard surface cleaning liquids and powders, aqueous and non-aqueous sprays, candles, gels, air freshening devices, plug-in electrical devices and battery-operated devices for introducing compositions into spaces, and liquid wicking systems, pet litters, toilet rim blocks, garbage bags and containers, kitchen napkins, shoes and shoe cabinets, air purification filters, air conditioning systems for indoor and vehicles, ventilation devices for vehicles, car panels and furniture, upholstered furniture, synthetic foams, plasters, paints, and adhesives.

The invention will now be further described and illustrated with reference to the following examples.

### Example 1

The malodour-counteracting effect of perfume ingredients was assessed using a balanced incomplete block/six component mixture design (Montgomery, D. C. (2012), Design and Analysis of Experiments, 8^{th} Edition John Wiley & Sons Inc). Each ingredient was included at typical usage levels known to those skilled in the art and occurred in the same number of mixes as all other ingredients.

Each fragrance mixture was diluted to 10% in diethyl phthalate and assessed for its ability to reduce the perception of sweat malodour using the following in vitro protocol:

Each diluted fragrance mix and sweat malodour were placed alongside each other in a 500 ml glass vessel as follows: 50 μl of sweat malodour was applied evenly onto a cotton pad (5.5 cm diameter) and the pad placed on top of a squat 15 ml jar alongside a diluted fragrance mix (1 ml in a 15 ml upright jar). An equivalent jar containing a blank formulation (diethylphthalate) was prepared using the same process (malodour control). The vessel was closed and allowed to equilibrate for half an hour before assessment.

A trained sensory panel consisting of at least 25 members was used to assess each sample, which was presented in random order. At least 30 assessments were made per sample. All assessments reported in the examples were carried out in a purpose built panel suite. The suite is designed so that all external distractions (i.e. odour, noise, movement) were eliminated, and the panelists were not distracted during testing.

Each panel member assessed each sample for the intensity of malodour that could be perceived in the headspace of the glass vessel using a line scale anchored at the extremes (0-100). The malodour control was used as a standard (perceived intensity 75) against which all other perceived intensities were scaled.

The data for all mixes were analysed using regression analysis (Montgomery, D. C. (2012). Design and Analysis of Experiments, 8^{th} Edition John Wiley & Sons Inc), with a separate parameter for each ingredient. In this way, the effect of an ingredient in the respective mixtures on reducing malodour could be estimated.

Several ingredients were identified as providing the greatest malodour counteracting (MOC) effect. These were split into two groups (A & B) based on relative MOC effect (A being the most efficacious).

| Name | % in mix | Estimate of Effect | Probability |
|---|---|---|---|
| ORANGE OIL BRAZIL (A) | 5 | −94.8 | 7.0247E−07 |
| CITRONELLAL (3,7-dimethyloct-6-enal) (A) | 1 | −93.4 | 3.83801E−05 |
| NONANAL (A) | 1 | −91.9 | 1.70839E−06 |
| ETHYL METHYL-2-BUTYRATE (ethyl 2-methylbutanoate) (A) | 1 | −90.6 | 9.72933E−07 |
| DECENAL-4-TRANS ((E)-dec-4-enal) (A) | 0.5 | −88.7 | 0.000123504 |
| ROSYRANE SUPER (4-methylene-2-phenyltetrahydro-2H- | 0.5 | −87.7 | 0.000145277 |
| pyran) (A) | | | |
| ISOAMYL ACETATE EXTRA (isopentyl acetate) (A) | 1 | −87.3 | 0.000249262 |
| PRENYL ACETATE (3-methylbut-2-en-l-yl acetate) (A) | 5 | −86.6 | 2.53465E−06 |
| GARDENOL (1-phenylethyl acetate) (A) | 1 | −85.7 | 0.000233845 |
| TRICYCLAL (2,4-dimethylcyclohex-3-enecarbaldehyde) (A) | 0.5 | −85.3 | 0.000401295 |
| EUCALYPTUS GLOBULUS OIL CHINA COSMOS (B) | 5 | −76.7 | 0.000594896 |
| LEMONILE ((2E,6Z)-3,7-dimethylnona-2,6-dienenitrile) (B) | 1 | −75.6 | 0.001048138 |
| ETHYL CAPROATE (ethyl hexanoate) (B) | 5 | −72.3 | 0.001668822 |
| CITRAL ((E)-3,7-dimethylocta-2,6-dienal) (B) | 5 | −69.7 | 0.002759761 |
| EUGENOL (4-allyl-2-methoxyphenol) | 1 | −39.6 | 0.061394188 |
| MANZANATE (ethyl 2-methylpentanoate) | 1 | −39.2 | 0.064671355 |
| METHYL CINNAMATE (methyl 3-phenylprop-2-enoate) | 5 | −38.3 | 0.082574778 |
| BENZYL ACETATE | 5 | −33.1 | 0.030276303 |
| CITRONELLYL ACETATE (3,7-dimethyloct-6-en-1-yl acetate) | 5 | −22.2 | 0.289071066 |
| GERANYL ACETATE SYNTHETIC ((E)-3,7-dimethylocta-2,6- | 5 | −19.8 | 0.326791537 |
| dien-1-yl acetate) | | | |
| AGRUMEX (2-(tert-butyl)cyclohexyl acetate) | 5 | −19.7 | 0.180787547 |
| HEDIONE (methyl 3-oxo-2-pentylcyclopentaneacetate) | 5 | −18.2 | 0.373789702 |
| MEFROSOL (3-methyl-5-phenylpentan-1-ol) | 5 | −12.9 | 0.372393934 |
| METHYL SALICYLATE (methyl 2-hydroxybenzoate) | 0.5 | −12.8 | 0.375214904 |
| LINALYL ACETATE (3,7-dimethylocta-1,6-dien-3-yl acetate) | 5 | −10.3 | 0.46429429 |
| BENZYL SALICYLATE (benzyl 2-hydroxybenzoate) | 5 | −9.4 | 0.524644363 |
| CAMPHOR((1S,4S)-1,7,7-trimethylbicyclo[2.2.1]heptan-2- | 5 | 0.3 | 0.988108819 |
| one) | | | |
| ALDEHYDE C 11 UNDECYLENIC (undecanal) | 0.5 | 8.3 | 0.67579042 |
| JASMATONE (2-hexylcyclopentanone) | 0.5 | 12.4 | 0.542971619 |

### Example 2

Core-shell microcapsules of the following fragrance formulations (36% fragrance loading) were prepared as described below:

One kilogram of encapsulated perfume composition slurry was formed according to the following method: A reactor was set to a temperature of 20° C. and was charged with deionised water (550 g); resorcinol as cross-linker (10 g); positively charged polymeric colloid stabilizer (Floset 371L) (2 g); and melamine formaldehyde precondensate (Luracoll SD) (5 g). The stirring speed was set to 400 rpm. At this stage, a perfume composition (300 g) was added.

Coacervation was undertaken in the following manner: Formic acid (10%) was added and the mixture was stirred for 1 h at 35° C. Then, the reactor temperature was increased to 90° C. for 1 h.

A cationic suspending agent (Flosoft FS222) was added to the mixture over a 30 min period under stirring. Finally, the pH of the slurry was adjusted to a pH range of 5.7 to 6.7 by adding a quantity of Ammonia (1 g). Thereafter, the slurry of encapsulated perfume composition was discharged from the reactor.

### Example 3

Encapsulated perfume compositions formed in accordance with the methodology of Example 1 were tested.

In tables 1 and 2 below, compositions B and C are embodiments of the invention. Compositions A, D and E are comparative reference formulae.

TABLE 1

| | | % of ingredient | | |
|---|---|---|---|---|
| Ingredient | RV | Composition A | Composition B | Composition C |
| PRENYL ACETATE (3-methylbut-2-en-1-yl | 1039 | 1.5 | | 10.0 |
| acetate) (A) | | | | |
| ETHYL METHYL-2-BUTYRATE (ethyl 2- | 1069 | | | 15.0 |
| methylbutanoate) (A) | | | | |
| ISOAMYL ACETATE (isopentyl acetate) (A) | 1071 | 0.5 | | |
| TRICYCLAL (2,4-dimethylcyclohex-3- | 1138 | | 15.0 | 25.0 |
| enecarbaldehyde) (A) | | | | |
| YARA YARA (2-methoxynaphthalene) | 1169 | | 1.5 | |
| ORANGE OIL BRAZIL (A) | 1203 | 65.0 | 5.0 | |
| TERPINOLENE (1-methyl-4-(propan-2- | 1204 | | | |
| ylidene)cyclohex-1-ene) | | | | |
| GARDENOL (1-phenylethyl acetate) (A) | 1246 | | 5.0 | |
| EUCALYPTUS GLOBULUS OIL CHINA COSMOS (B) | 1278 | 10.0 | 20.0 | 10.0 |
| CITRAL ((E)-3,7-dimethylocta-2,6-dienal) (B) | 1311 | 5.0 | | |
| LINALOOL (3,7-dimethylocta-1,6-dien-3-ol)(B) | 1367 | | 9.0 | 5.0 |
| JASMACYCLENE | 1418 | | 10.0 | |
| (3aR,6S,7aS)-3a,4,5,6,7,7a-hexahydro-1H-4,7- | | | | |
| methanoinden-6-yl acetate) | | | | |
| TETRAHYDRO LINALOOL (3,7-dimethyloctan- | 1449 | | | |
| 3-ol) | | | | |
| TETRAHYDRO MYRCENOL (2,6- | 1449 | 17.5 | 9.0 | |
| dimethyloctan-2-ol)(B) | | | | |
| BIGARYL (8-(sec-butyl)-5,6,7,8- | 1563 | 0.5 | | |
| tetrahydroquinoline)(B) | | | | |
| BORNYL ACETATE LIQUID ((2S,4S)-1,7,7- | 1631 | | | |
| trimethylbicyclo[2.2.1]heptan-2-yl acetate) | | | | |
| DAMASCONE DELTA ((E)-1-(2,6,6- | 1654 | | | 2.0 |
| trimethylcyclohex-3-en-1-yl)but-2-en-1-one) | | | | |
| ALDEHYDE C 12 MNA PURE (2-methyl- | 1661 | | 3.0 | |
| undecanal)(B) | | | | |
| AGRUMEX (2-(tert-butyl)cyclohexyl acetate) | 1678 | | 14.5 | 25.0 |
| HEXYL SALICYLATE (hexyl 2-hydroxybenzoate) | 1685 | | 6.0 | |
| NECTARYL (2-(2-(4-methylcyclohex-3-en-1- | 1822 | | 2.0 | 8.0 |
| yl)propyl)cyclopentanone) | | | | |

| | | | |
|---|---|---|---|
| RECON_VOLTAE < 1200 Bohr³ | 2.0 | 16.5 | 50.0 |
| RECON_VOLTAE from 1200 Bohr³ to 1540 Bohr³ | 97.5 | 58.0 | 15.0 |
| RECON_VOLTAE > 1540 Bohr³ | 0.5 | 25.5 | 35.0 |
| Group A ingredients % | 67.0 | 25.0 | 50.0 |
| Group B ingredients % | 33.0 | 41.0 | 15.0 |
| Number of Group A ingredients | 3 | 3 | 3 |
| Number of Group B ingredients | 4 | 4 | 2 |

TABLE 2

| | | % of ingredient | |
|---|---|---|---|
| Ingredient | RV | Composition D | Composition E |
| INDOLE PURE (1H-indole) | 870 | | 0.05 |
| YARA YARA (2-methoxynaphthalene) | 1169 | | 3 |
| GALBANUM RES SYNT IFRA/20/2 | 1204 | 0.0678 | |
| TERPINOLENE TERPINOLENE (1-methyl-4-(propan-2- | 1204 | | 3 |
| ylidene)cyclohex-1-ene) | | | |
| ORANGE TERPENES DISTILLED (A) | 1211 | | 10 |
| YLANG 2 MEF | 1220 | | 1.5 |
| EUGENOL (4-allyl-2-methoxyphenol) | 1242 | | 1 |
| MYRCENE 90 (7-methyl-3-methyleneocta-1,6-diene) | 1259 | 0.0022 | |
| THYMOL CRYSTALS (2-isopropyl-5-methylphenol) | 1277 | | 0.05 |
| EUCALYPTOL ((1s,4s)-1,3,3-trimethyl-2- | 1278 | 15 | |
| oxabicyclo[2.2.2]octane) (B) | | | |
| CITRAL ((E)-3,7-dimethylocta-2,6-dienal) (B) | 1311 | | 3 |
| ISOBUTYL METHOXY PYRAZINE (2-isobutyl-3- | 1311 | | 0.2 |
| methoxypyrazine) 0.1%/TEC | | | |
| ISOPROPYL QUINOLINE (6-isopropylquinoline) (B) | 1336 | | 0.1 |
| CABYLIS 4/20 | 1350 | | 0.3 |
| EVERNYL (methyl 2,4-dihydroxy-3,6-dimethylbenzoate) | 1362 | | 0.1 |
| METHYL OCTYNE CARBONATE (methyl non-2-ynoate) | 1376 | 0.1 | |
| JASMACYCLENE ((3aR,6S,7aS)-3a,4,5,6,7,7a-hexahydro- | 1417 | 22 | |
| 1H-4,7-methanoinden-6-yl acetate) | | | |
| ALLYL OENANTHATE (allyl heptanoate) | 1436 | | 1 |
| TETRAHYDRO LINALOOL (3,7-dimethyloctan-3-ol) | 1449 | 24 | 25 |
| LEMONILE ((2E,6Z)-3,7-dimethylnona-2,6-dienenitrile) | 1515 | | 1 |
| (B) | | | |
| UNDECAVERTOL ((E)-4-methyldec-3-en-5-ol) | 1531 | | 5 |
| AMYL SALICYLATE (pentyl 2-hydroxybenzoate) | 1556 | 6.5 | |
| ALDEHYDE C 12 MNA PURE (2-methyl-undecanal) (B) | 1661 | | 0.2 |
| IONONE BETA ((E)-4-(2,6,6-trimethylcyclohex-1-en-1- | 1670 | | 1 |
| yl)but-3-en-2-one) (B) | | | |
| CITRONELLYL ACETATE (3,7-dimethyloct-6-en-1-yl | 1678 | | 5 |
| acetate) | | | |
| BUTYL CYCLOHEXYL ACETATE PARA (4-(tert- | 1682 | 25.03 | |
| butyl)cyclohexyl acetate) | | | |
| PATCHOULI OIL IRONFREE INDONESIA (B) | 1750 | | 2 |
| HEDIONE (methyl 3-oxo-2-pentylcyclopentaneacetate) | 1784 | | 19 |
| ISORALDEINE 70 ((E)-3-methyl-4-(2,6,6- | 1806 | | 5 |
| trimethylcyclohex-2-en-1-yl)but-3-en-2-one) | | | |
| NECTARYL (2-(2-(4-methylcyclohex-3-en-1- | 1822 | | 3 |
| yl)propyl)cyclopentanone) | | | |
| SPIROGALBANONE PURE (1-(spiro[4.5]dec-6-en-7- | 1833 | 0.8 | |
| yl)pent-4-en-1-one) | | | |
| JAVANOL ((1-methyl-2-((1,2,2- | 1930 | 0.5 | |
| trimethylbicyclo[3.1.0]hexan-3- | | | |
| yl)methyl)cyclopropyl)methanol) | | | |
| AMBROFIX (3a,6,6,9a- | 2039 | 0.4 | |
| tetramethyldodecahydronaphtho[2,1-b]furan) | | | |
| KARANAL (5-(sec-butyl)-2-(2,4-dimethylcyclohex-3-en-1- | 2242 | 2 | |
| yl)-5-methyl-1,3-dioxane) | | | |
| ISOPROPYL MYRISTATE | 2379 | | 10.5 |
| HERCOLYN DW (methyl hydrogenated rosinate) | 2656 | 3.6 | |

| | | |
|---|---|---|
| Recon Voltae < 1200 Bohr³ | 0 | 3.05 |
| Recon Voltae from 1200 Bohr³ to 1540 Bohr³ | 67.67 | 51.25 |
| Recon Voltae > 1540 Bohr³ | 38.83 | 45.7 |
| Group A ingredients % | 0 | 10 |
| Group B ingredients % | 15 | 6.3 |
| Number of Group A ingredients | 0 | 1 |
| Number of Group B ingredients | 1 | 6 |

Microcapsules were dosed at 0.5% into unperfumed fabric conditioner and left to mature at room temperature for 3 days (fresh). Samples of these fabric conditioners were also placed on accelerated storage by placing them in ovens at 37° C./3 weeks to check for stability of microcapsules overtime.

Squares of cotton cloth (measuring 22 cm×18 cm) were included with a standardised wash ballast and washed in unfragranced detergent powder (40 g) followed by washing with fabric conditioner samples (35 g) containing the encapsulated accords as detailed above (40° C.—1000 rpm) Cloths were line dried overnight in a temperature controlled room (24° C. and relative humidity 52%)

The dried cloths were placed over the opening of a 500 ml powder jar which contained a cotton pad (5.5 cm diameter) with 50 μl of model sweat malodour at the bottom. Samples were randomly coded and left to equilibrate for 30 min prior to assessment by a trained sensory panel. As a control, a sample covered by a cloth washed in unperfumed fabric conditioner base only (no microcapsules) was also prepared.

Immediately prior to assessment, cloths were rubbed by the sensory panelists using index and middle fingers in standardised zig-zag fashion to break the encapsulates. Each sample was replaced after three assessments. The panelists assessed the intensity of sweat malodour through the cloth using a 0-100 line scale with reference to the control sample where the malodour intensity was set at 45. The order of samples assessed by the panelists was pre-determined using a fully balanced randomisation. The products were assessed in a sequential monadic way. Results were analysed using an ANOVA model.

Malodour reduction shown from cloths washed in fresh and stored conditioners containing capsules with embodiment malodour counteracting and stable Compositions B and C was greater than that seen from the equivalent samples washed in standard Composition D (Tables 3 and 4).

Although capsules containing Composition A (100% Group A and B ingredients) outperforms Composition E when used from a freshly prepared fabric conditioner, the efficacy is lost after storage due to composition/capsule instability in the base (Tables 5 and 6).

TABLE 3

| | Malodour | Difference from unperfumed |
|---|---|---|
| | Intensity | fabric conditioner base only |
| Composition C (Fresh) | 13.5 | 24.6 |
| Composition B (Fresh) | 19.5 | 18.6 |
| Composition D (Fresh) | 29.1 | 9.0 |
| Base only (Fresh) | 38.1 | |

TABLE 4

| | Malodour | Difference from unperfumed |
|---|---|---|
| | Intensity | fabric conditioner base only |
| Composition C (Stored) | 24.1 | 14.0 |
| Composition B (stored) | 26.3 | 11.8 |
| Composition D (Stored) | 31.1 | 7.0 |
| Base only (Fresh) | 38.1 | |

TABLE 5

| | Malodour | Difference from unperfumed |
|---|---|---|
| | Intensity | fabric conditioner base only |
| Composition A (Fresh) | 21.2 | 22.3 |
| Composition E (Fresh) | 36.2 | 7.3 |
| Base only (Fresh) | 43.5 | |

TABLE 6

| | Malodour | Difference from unperfumed |
|---|---|---|
| | Intensity | fabric conditioner base only |
| Composition E (Stored) | 29.9 | 9.9 |
| Composition A (Stored) | 35.4 | 4.4 |
| Base (Fresh) | 39.8 | |

1. A malodour counteracting perfume composition comprising at least 10 wt % of at least four ingredients drawn from the following groups Group A and Group B, wherein the composition comprises at least 10% in total of at least two of the following Group A ingredients:
Group A: Citronellal, Citronellol, Cyclal C, Gardenol, Decenal-4-trans, ethyl 2 methyl butyrate, hexenyl-3-cis acetate, hexyl acetate, isoamyl acetate extra, Litsea cubeba oil, nonanal, Orange oil, Orange terpenes, prenyl acetate, Rose Oxide, Rosyrane super, and Tricyclal; and
and further wherein the composition optionally comprises at least two of the following Group B ingredients:
Group B: Adoxal, Aldehyde C 12 MNA, allyl cyclo propionate, amyl butyrate, Armoise oil Morocco, Bigaryl, cinnamic aldehyde, Citral, ethyl caproate, Eucalyptol, Eucalyptus oil, Georgywood, hexyl isobutyrate, Ionone beta, isobutyl isobutyrate, isobutyl quinolone, isopropyl methyl-2-butyrate, Lemonile, Linalool synthetic, Melonal, methyl amyl ketone, methyl benzoate, methyl heptenone, methyl hexyl ketone, phenyl ethyl acetate, tetrahydro myrcenol, Patchouli Oil, tridecen-2-nitrile, Calypsone, Cassyrane, Mahonial, Rosyfolia, and Nympheal.

2. A malodour counteracting perfume composition according to claim 1 wherein the perfume composition is encapsulated.

3. A malodour counteracting perfume composition, wherein the encapsulated perfume composition comprises at least one perfume containing a core-shell microcapsule suspended in a suspending medium, and the encapsulated perfume is a malodour counteracting perfume composition according to claim 1.

4. A malodour counteracting perfume composition according to claim 3,
wherein
at least 10 wt %, of the perfume ingredients have a RECON_VOLTAE value higher than 1540 Bohr³; and also,
from 20 to 90 wt %, of the perfume ingredients have a RECON_VOLTAE value lower than 1540 Bohr³.

5. A method of reducing or eliminating the perception of body malodour or environmental malodours comprising the step of: utilizing the malodour counteracting perfume composition of claim 1.

6. A method of reducing or eliminating the perception of body malodour or environmental malodour, comprising the step of:
applying a malodour counteracting perfume composition of claim 2 to a site in need of treatment.

7. A method according to claim 6, wherein the site in need of treatment is human or animal skin or is a hair, fabric or household surface.

8. A consumer product comprising a malodour counteracting perfume composition according to claim 2.

9. A method of reducing or eliminating the perception of body malodour or environmental malodour, comprising the step of applying a malodour counteracting composition according to claim 3 to a site in need of treatment.

10. A method of reducing or eliminating the perception of body malodour or environmental malodour, comprising the step of applying a malodour counteracting composition according to claim 4 to a site in need of treatment.

11. A malodour counteracting perfume composition according to claim 4, wherein at least 15 wt %, of the perfume ingredients have a RECON_VOLTAE value higher than 1540 Bohr³.

12. A malodour counteracting perfume composition according to claim 11, wherein at least 20 wt %, of the perfume ingredients have a RECON_VOLTAE value higher than 1540 Bohr³.

13. A malodour counteracting perfume composition according to claim 4, wherein 30 to 80 wt % of the perfume ingredients have a RECON_VOLTAE value lower than 1540 Bohr³.

14. A malodour counteracting perfume composition according to claim 13, wherein 50 to 75 wt % of the perfume ingredients have a RECON_VOLTAE value lower than 1540 Bohr³.
